(19) United States
(12) Patent Application Publication
(10) Pub. No.: US 2014/0215174 A1
(43) Pub. Date: Jul. 31, 2014

(54) Accessing Memory with Security Functionality

(71) Applicant: Infineon Technologies AG, Neubiberg (DE)

(72) Inventors: Jan Otterstedt, Unterhaching (DE); Steffen Sonnekalb, Taufkirchen (DE); Andreas Wenzel, Muenchen (DE)

(21) Appl. No.: 13/750,466

(22) Filed: Jan. 25, 2013

(51) Int. Cl. G06F 12/14

(52) U.S. Cl. CPC G06F 12/1458
USPC 711/163

(57) ABSTRACT

A memory device includes a first memory portion and a second memory portion. The second memory portion includes a security functionality. The size of the first memory portion and the size of the second memory portion are adjustable.

### TECHNICAL FIELD

Embodiments of the present invention relate to a memory unit or chip that comprises a secured portion of memory, particularly a memory area for which a security functionality is provided such as an error code to determine, e.g., whether the memory is corrupt or was subject to an attack which may have changed its content.

### BACKGROUND

Basically, two types of microcontroller appliances are known for providing security functionality: First, the microcontroller provides the security functionality by adding security modules like sensors around the microprocessor system. Second, the microcontroller implements security by integrating the security features directly into the microprocessor system including (but not limited to) its memory.

The downside of the protected memory is the area overhead required, e.g., for added error codes necessary for the complete memory.

On the other hand, in many use case scenarios, only a portion of the application that may be implemented on the secure microcontroller needs the security functionality.

### SUMMARY

A first embodiment relates to a memory device comprising a first memory portion and a second memory portion, the second memory portion comprising a security functionality. The size of the first memory portion and the size of the second memory portion are adjustable. Preferably, only the second memory portion comprises a security information, e.g., an EDC code, that is used on payload data of the second memory portion of the memory device. The first memory portion may be a standard memory without the security functionality provided for the second memory portion.

A second embodiment relates to an integrated circuit pursuant to the memory device of the first embodiment.

A third embodiment relates to a method for accessing a memory, wherein a request for accessing the memory is received. The memory comprises a first memory portion and a second memory portion, the second memory portion comprising payload data security information. Data comprising payload data and security information is retrieved from the memory based on the received request, the security information is processed, and a response is issued comprising the payload data pursuant to the received request.

A fourth embodiment is directed to a system for accessing the memory comprising: means for receiving a request for accessing the memory, wherein the memory comprises a first memory portion and a second memory portion, the second memory portion comprising payload data security information. The system further comprises means for retrieving data comprising payload data and security information from the memory based on the received request, means for processing the security information, and means for issuing a response comprising the payload data pursuant to the received request.

A fifth embodiment relates to an access and control device for accessing a memory via a mapping scheme comprising: means for receiving a request for accessing the memory from a processor, wherein the memory comprises a first memory portion and a second memory portion, the second memory portion comprising payload data security information. The device further comprises means for mapping the received request to an address of the memory, means for retrieving data comprising payload data and security information from the address of the memory, means for processing the security information, and means for issuing a response to the processor comprising the payload data pursuant to the received request.

### BRIEF DESCRIPTION OF THE DRAWINGS

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a schematic diagram of an access and control mechanism that is (logically) deployed between a central processing unit and a memory;

FIG. 2 shows exemplary arrangements of several page layouts for a memory, e.g., the memory as depicted in FIG. 1; and

FIG. 3 shows a table comprising several examples of page configurations.

### DETAILED DESCRIPTION

Embodiments described herein enable an increased flexibility for a memory which comprises a protected area, i.e. a memory portion for which a security functionality could be used. This allows for use case scenarios with a high degree of flexibility depending on the actual demand for protected memory. The demand may even vary and thus the protected memory, i.e. the memory portion with security functionality, could be adapted, e.g., with regard to its size.

Hence, advantageously, an area overhead is limited and error codes are preferably only provided for the part of the application that requires the security features. Due to the limited overhead, the approach presented allows saving costs, reducing power consumption and increasing performance.

Exemplary applications for the solution presented comprise embedded microcontroller applications, e.g., in the field of smart metering, wherein only a minor portion of the overall application may have a need for security features.

It is noted that the “security functionality” referred to herein also comprises the aspects of a safety functionality and/or a reliability functionality. Insofar, several memory portions could be provided also for safety and/or reliability reasons. The solution presented is thus in particular applicable for applications or scenario that tries to detect and/or avoid errors, e.g., via ECC or EDC information. The size of the memory portion with such security functionality may vary due to the demands of a particular use case scenario.

It is further noted that a security functionality may be applicable to a portion of a memory, wherein the security information, e.g., an error code, is associated with payload data that is stored in this portion of the memory. The security information can be a code that allows determining whether the payload data is corrupt and/or to at least partly restore the payload data by utilizing some redundancy information that can be part of the security information.

Hence, the security information may be any EDC means. EDC (error detection and correction or error control) are techniques that enable, e.g., reliable delivery of digital data over unreliable communication channels. Error detection techniques allow detecting errors, while error correction enables reconstruction of the original data.

A memory device may be provided that comprises two portions of memory, i.e. a first and a second portion, wherein the second portion comprises a security functionality. The size of the first portion and the size of the second portion can be flexibly adjusted. It is also an option that the memory device comprises several portions, wherein at least one of the portions can be equipped with or for a security functionality. The security functionality comprises a security information that is associated with the second portion of the memory, wherein the security information can in particular be or comprise an error code (e.g., an EDC code) that allows detecting errors in the payload data of this second portion.

Hence, a common memory configuration without dedicated security features like error detection and correction codes (EDC codes) can be used for non-security parts of an application. The approach presented allows, e.g., a logical separation of such common memory into a normal memory area and a protected memory area, wherein the latter uses at least one security feature or functionality. Such logical separation can be supplied in a flexible manner depending on a particular use case scenario, e.g., on the need for protected memory space.

For the security relevant part of the application, additional security requirements can be mapped onto the common memory configuration by implementing a modified access and control mechanism. Hence, only for the memory space used as protected memory (i.e. memory with security functionality), a part of the common memory space can be redefined, e.g., to implement error codes.

This approach is also beneficial, because the access and control mechanism can be supplied with little additional costs. Another advantage stems from the fact that the size for the secure and normal memory can be flexibly adjusted, e.g., configured based on a particular use case scenario.

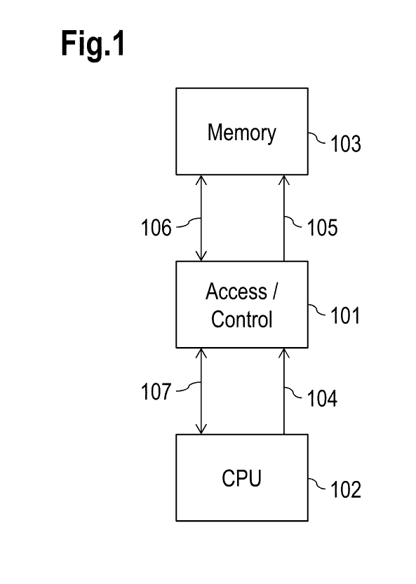

FIG. 1 shows a schematic diagram of an access and control mechanism 101 that is (logically) provided between a central processing unit (CPU) 102 and a memory 103. The memory 103 can be a common or standard memory, in particular a non-volatile memory (NVM) or a random access memory (RAM). The CPU 102 sends a logical address 104 to the access and control mechanism 101, which determines a mapped address 105 to access the memory 103. Data 104 is conveyed to the memory 103 and further as data 107 to the CPU 102 (or vice versa). Hence, the access and control mechanism 101 provides a transparent service for the CPU 102 for accessing the memory 103 in an efficient manner taking into consideration that a portion of the memory 103 is protected, i.e. associated with some security functionality.

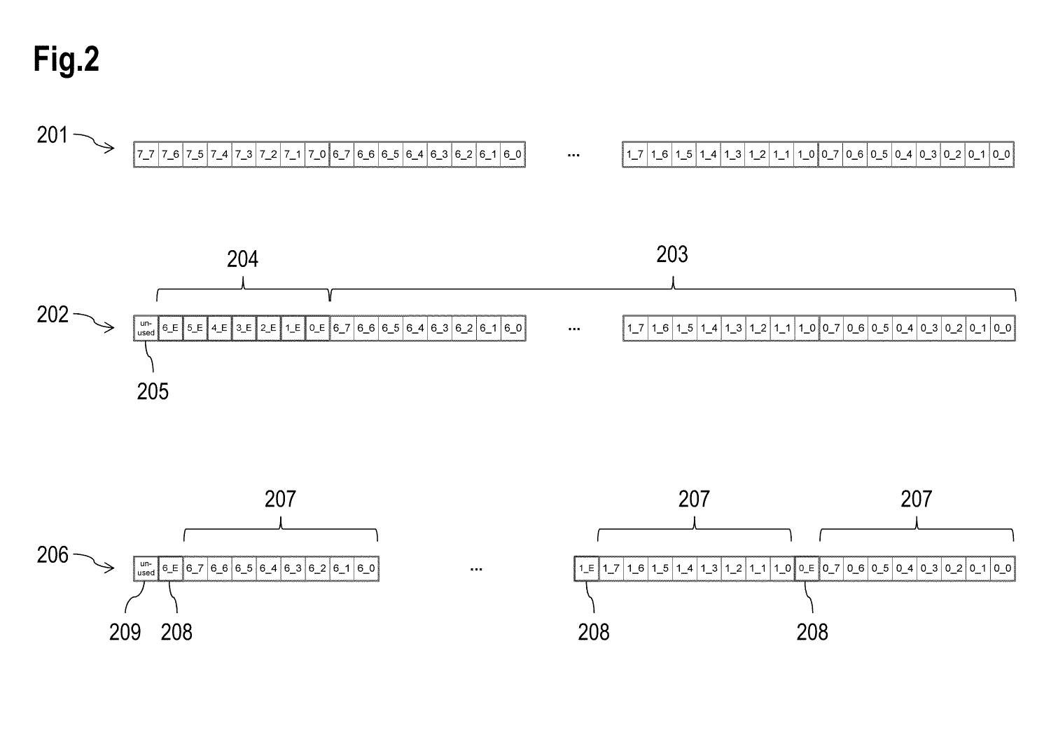

FIG. 2 shows exemplary arrangements of several page layouts for a memory, e.g., the memory 103 depicted in FIG. 1.

A memory layout 201 comprises n pages, wherein each page contains 8 blocks. Each block comprises eight 32-bit words. For a NVM, the page itself may be the smallest unit to be erased. For other memories like RAM, the page is a convenient description for a set of blocks or words.

FIG. 2 also shows a layout 202 of a memory, which has a secure configuration. The memory 202 comprises seven usable data blocks 203 (i.e. data blocks that can be used for payload data and are not occupied by secure information like, e.g., error codes) and a block 204 (i.e. security overhead) redefined for storing error codes for the seven data blocks 203. In this layout 202, a single 32-bit word 205 remains unused.

Software development tools and software for accessing the memory each usually requires a linear address map of the (complete) memory without any gaps in the address space. This can be fulfilled for a common memory configuration, but not necessarily for the secure memory configuration. Hence, with regard to the secure memory configuration (or the complete memory space), the access and control mechanism 101 provides (e.g., a hardware-based) mapping for the CPU 102 such that the data portions of the memory 103 can be accessed in a linear manner, i.e. without any gaps which are used for error codes. Hence, the error codes are advantageously hidden from the CPU 102 and processed by the access and control mechanism 101. If an error is detected based on, e.g., corrupt data, the access and control mechanism 101 may inform the CPU 102 and/or trigger an exception handling mechanism.

Hence, advantageously, the CPU 102 accesses the memory 103 via the access and control mechanism 101 as if all data are in sequence and can be accessed one after another. The handling of the security functionality is done by the access and control mechanism 101 in a transparent manner to the CPU 102. Hence, the physical representation of the actual data (i.e. where each word is stored) can be managed by the access and control mechanism 101. This allows a high degree of flexibility as the access and control mechanism 101 may utilize the memory layout in various ways and provide said transparent service to the CPU 102. To the CPU 102, the payload data can be accessed in a linear manner, the CPU 102 does not have to manage the error codes or any gaps in the (physical) memory.

NVMs may have a restriction that a page is the smallest unit that can be erased. However, the logical page size for the page layout 202 with the security overhead 204 is smaller and not a power of two, since due to security reasons, for the secure memory layout eight data words plus one EDC word are written and read, whereas for the unsecured case of the page layout 201 only the eight data words and no EDC word need to be written and read. Such different layouts and operations are handled by the access and control mechanism 101 and are preferably transparent to the CPU 102 and application (software) using this sort of memory 103.

In particular for HS3P (Hot Source Triple Poly) memory cells with an incremental write feature, an erased page can be written in random order, which supports the access scheme. A write access may internally comprise a standard data block write plus an EDC word write in the reserved EDC block. Other write sequences and page layouts (different positions of EDC words) are possible. A page layout 206 comprises seven usable data blocks 207 and an EDC word 208 associated with each data block 207 for storing error codes. A single 32-bit word 209 remains unused.

In FIG. 2, a box comprising the label “x_y” indicates a 32-bit word y of block x and the label “x_E” indicates a 32-bit EDC word of block x. The logical order of words shown in FIG. 2 is meant as an example only and does not have to reflect a physical implementation. For example, the words and even the bits of the words shown in the page layouts 201, 202 and 206 could be scrambled according to standard physical memory layouts.

Error detection and correction mechanisms are known. The solution presented can be combined with the approach described in U.S. Pat. No. 7,937,639 B2 (Sonnekalb), which is incorporated herein by reference in its entirety. The words could be ECC-protected together with the data words, i.e. the data words and the respective EDC word may constitute one ECC-protected block.

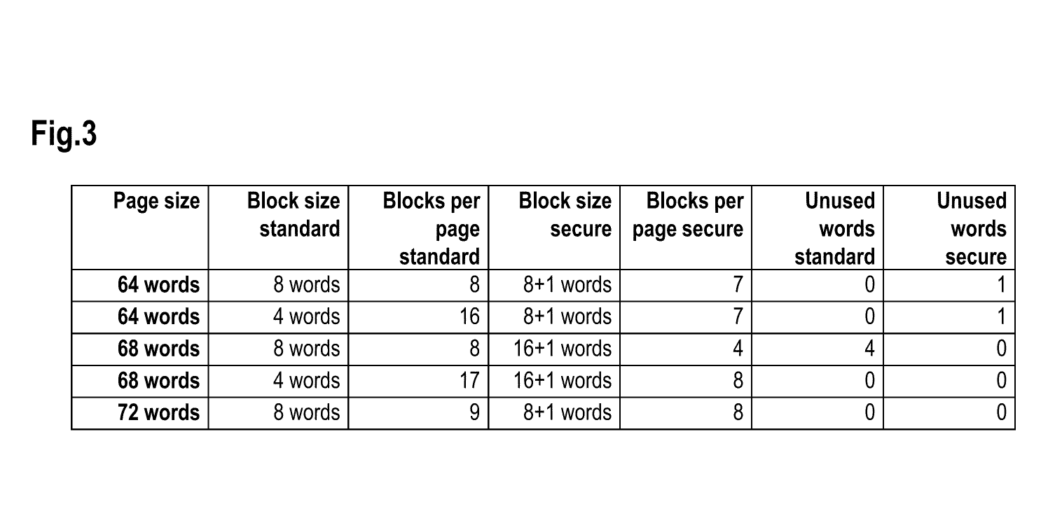

FIG. 3 shows a table comprising several examples of page configurations. Advantageous configurations may be directed to blocks per page with a standard being a power of two.

The first line in the table indicates an exemplary page with a total size amounting to 64 words. In the standard unsecured case these 64 words are utilized as eight blocks each having eight words. In the secured case the same 64 words are utilized as seven protected blocks each having eight data words and one EDC word. In this case a single word in the secured memory portion is not used.

The second line in the table indicates an exemplary page with a total size amounting to 64 words. In the standard unsecured case these 64 words are utilized as 16 blocks with four words each. In the secured case the same 64 words are utilized as seven protected blocks each having eight data words and one EDC word. In this case a single word in the secured memory portion is not used.

The third line in the table indicates an exemplary page with a total size amounting to 68 words. In the standard unsecured case these 68 words are utilized as eight blocks each with eight words and four words are not used. In the secured case the same 68 words are utilized as four protected blocks each having 16 data words and one EDC word. In this case all words in the secured memory portion are used.

The fourth line in the table indicates an exemplary page with a total size amounting to 68 words. In the standard unsecured case these 68 words are utilized as 17 blocks each with four words. In the secured case the same 68 words are utilized as four protected blocks each having 16 data words and one EDC word. In both cases all words are used.

The last line in the table indicates an exemplary page with a total size amounting to 72 words. In the standard unsecured case these 72 words are utilized as nine blocks each with eight words. In the secured case the same 72 words are utilized as eight protected blocks each having eight data words and one EDC word. In both cases all words are used.

Hence, a memory device can be partitioned into at least two memory portions, a first memory portion with no security functionality and a second memory portion with a security functionality. Of course, several such first and second portions can be used for the memory device accordingly. The first and second portions can be structured as blocks of equal or different sizes. The first and second portions can be structured as pages comprising such blocks. A group of blocks (comprising at least one block) may have the same size or different sizes. A block may comprise at least one word, wherein each word may comprise a predefined number of bits. It is also an option, that words with a different number of bits are used. The first memory portion can be structured as, similar to or different from the second memory portion.

The first memory portion and the second memory portion each comprise at least one memory from the following group: RAM, ROM, EEPROM, floating gate NVM, PCRAM, CBRAM, nano-crystal NVM, HS3P, ETOX, MRAM, MONOS and TANOS.

The memory device suggested herein could be an embedded memory or a stand-alone memory device (e.g., memory chip).

Also, the memory device may comprise several partitions, wherein at least one of the partitions is a partition with a security functionality.

Exception handling or fault management can be triggered in case the EDC code indicates an error. In such case, the system for accessing the memory may provide a message to a processor or conduct a predefined action.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

What is claimed is:

1. A memory device, comprising:
a first memory portion;
a second memory portion;
wherein the second memory portion comprises a security functionality; and
wherein a size of the first memory portion and a size of the second memory portion are adjustable.

2. The memory device according to claim 1, wherein the security functionality comprises a security information associated with data of the second memory portion.

3. The memory device according to claim 2, wherein the security information comprises an error code.

4. The memory device according to claim 2, wherein the security information comprises an error code for each block of the data of the second memory portion.

5. The memory device according to claim 1, wherein the second memory portion comprises several blocks, each block comprises at least one word.

6. The memory device according to claim 5, wherein the at least one word comprises a predefined number of bits.

7. The memory device according to claim 5, wherein several words comprise different numbers of bits.

8. The memory device according to claim 1, wherein the first memory portion comprises several blocks, wherein the blocks of the first memory portion comprise different numbers of words.

9. The memory device according to claim 1, wherein the second memory portion comprises several blocks, wherein the blocks of the second memory portion comprise different numbers of words.

10. The memory device according to claim 1, wherein the first and second memory portions each comprise several blocks, wherein the blocks of the first memory portion comprise the same or different number of words than the blocks of the second memory portion.

11. The memory device according to claim 1, wherein the memory device further comprises several pages, at least one page comprising the first memory portion and the second memory portion, wherein the size of the first memory portion is the same or is different for several pages.

12. The memory device according to claim 11, wherein the first memory portion comprises several blocks, in particular the same or a different number of blocks per page.

13. The memory device according to claim 11, wherein the second memory portion comprises several blocks, in particular the same or a different number of blocks per page.

14. The memory device according to claim 11,
wherein the first memory portion comprises several blocks, in particular the same or a different number of blocks per page;
wherein the second memory portion comprises several blocks, in particular the same or a different number of blocks per page; and
wherein the number of blocks of the first memory portion and the number of blocks of the second memory portion are the same or different per page.

15. The memory device according to claim 1, wherein the first memory portion and the second memory portion each comprise at least one memory from the following group: RAM, ROM, EEPROM, floating gate NVM, PCRAM, CBRAM, nano-crystal NVM, HS3P, ETOX, MRAM, MONOS and TANOS.

16. The memory device according to claim 1, wherein the memory device is an embedded memory.

17. The memory device according to claim 1, wherein the memory device is a stand-alone memory device.

18. The memory device according to claim 1, wherein the size of the first memory portion and the size of the second memory portion are adjustable via a single partition or via several partitions.

19. An integrated circuit comprising the memory device of claim 1.

20. A method for accessing a memory comprising a first memory portion and a second memory portion, the second memory portion comprising payload data security information, the method comprising:
receiving a request for accessing the memory;
retrieving data comprising payload data and security information from the memory based on the received request;
processing the security information; and
issuing a response comprising the payload data pursuant to the received request.

21. The method according to claim 20, wherein the security information comprises an EDC code.

22. The method according to claim 21, wherein the EDC code is verified and in case an error in the EDC code is detected an exception handling is initiated.

23. The method according to claim 20, wherein the request is received from and the response is issued to a processor.

24. The method according to claim 20, wherein the size of the first memory portion and the size of the second memory portion are adjusted.

25. The method according to claim 20, wherein the ratio between the payload data and the security information is adjusted.

26. The method according to claim 20, wherein the security information comprises code that allows determining whether the payload data is corrupt.

27. The method according to claim 20, wherein the security information comprises code that allows correction of the payload data in case an error is determined

28. A system for accessing a memory, comprising:
means for receiving a request for accessing the memory, the memory comprising a first memory portion and a second memory portion, the second memory portion comprising payload data security information;
means for retrieving data comprising payload data and security information from the memory based on the received request;
means for processing the security information; and
means for issuing a response comprising the payload data pursuant to the received request.

29. The system according to claim 28, wherein the security information comprises an EDC code.

30. The system according to claim 29, further comprising means for verifying the EDC code and for initiating an exception handling in case an error in the EDC code is detected.

31. An access and control device for accessing a memory via a mapping scheme comprising:
means for receiving a request for accessing the memory from a processor, the memory comprising a first memory portion and a second memory portion, the second memory portion comprising payload data security information;
means for mapping the received request to an address of the memory;
means for retrieving data comprising payload data and security information from the address of the memory;
means for processing the security information; and
means for issuing a response to the processor comprising the payload data pursuant to the received request.

32. The access and control device of claim 30, wherein the means for processing the security information comprises means for verifying the security information and initiating an exception handling in case an error is detected.
